(19) United States
(12) Patent Application Publication
(10) Pub. No.: US 2010/0009559 A1
(43) Pub. Date: Jan. 14, 2010

(54) ELECTRCAL CONNECTOR FOR RECEIVING A CPU

(75) Inventor: FANG-JWU LIAO, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/502,826

(22) Filed: Jul. 14, 2009

(30) Foreign Application Priority Data
Jul. 14, 2008 (TW) 97212469

(51) Int. Cl. H01R 12/00

(52) U.S. Cl. 439/79

(57) ABSTRACT

An electrical connector for receiving a CPU (1) includes a plurality of terminals (3) and an insulative housing (2). The insulative housing (2) includes a rectangular mating face (21), and the rectangular mating face defines a plurality of passageways, said plurality of terminals are received in the passageway. The mating face is surrounded by four lateral side walls (22), and the lateral side walls together with the mating face to form a cavity, the cavity is used to received the CPU (1). wherein the lateral side wall comprises an inner surface (220) facing the cavity, and the inner surface defines at least two fixing blocks (221) perpendicular to each other, and wherein, each fixing block has ribs to engage the CPU.

### BACKGROUND OF THE INVENTION

1. Field of the Invention

The present invention relates to an electrical socket connector, and more particularly to an electrical socket connector for receiving a central processing unit (CPU).

2. Description of Prior Arts

FIG. 1 shows a conventional electrical socket connector for receiving a CPU, which has a housing and two detachable flexible arms assembled to the housing. After the CPU is assembled to the socket, the arms engage with the CPU, so as to assure the CPU staying in the socket. However, the detachable arms complicate assembling operation, and the cost of the socket will increase.

Therefore, it is desirable to provide a new electrical socket connector that decreases the cost of the connector.

### SUMMARY OF THE INVENTION

Accordingly, an object of the present invention is to provide an electrical connector with low cost.

In order to achieve afore-mentioned object, An electrical connector for receiving a CPU includes a plurality of terminals and an insulative housing. The insulative housing includes a rectangular mating face, and the rectangular mating face defines a plurality of passageways, said plurality of terminals are received in the passageway. The mating face is surrounded by four lateral side walls, and the lateral side walls together with the mating face to form a cavity, the cavity is used to received the CPU. wherein the lateral side wall comprises an inner surface facing the cavity, and the inner surface defines at least two fixing blocks perpendicular to each other, and wherein, each fixing block has ribs to engage the CPU.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of a conventional electrical connector;

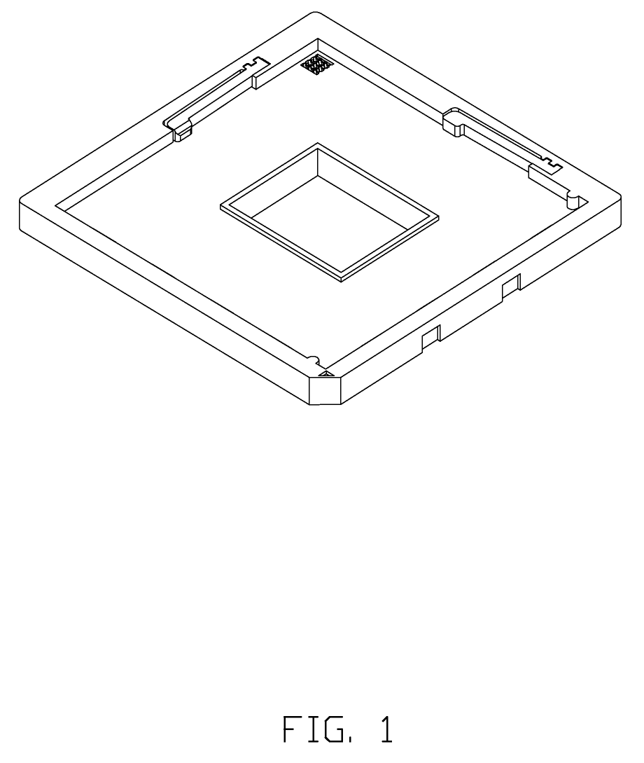

FIG. 2 is an exploded view of an electrical connector in accordance with the present invention;

FIG. 3 is an enlarged view of an encircled portion of the connector in FIG. 2; and

FIG. 4 is a top plan view of FIG. 2 after the CPU is assembled to the electrical connector.

### DETAILED DESCRIPTION OF THE PREFERRED EMBODIMENT

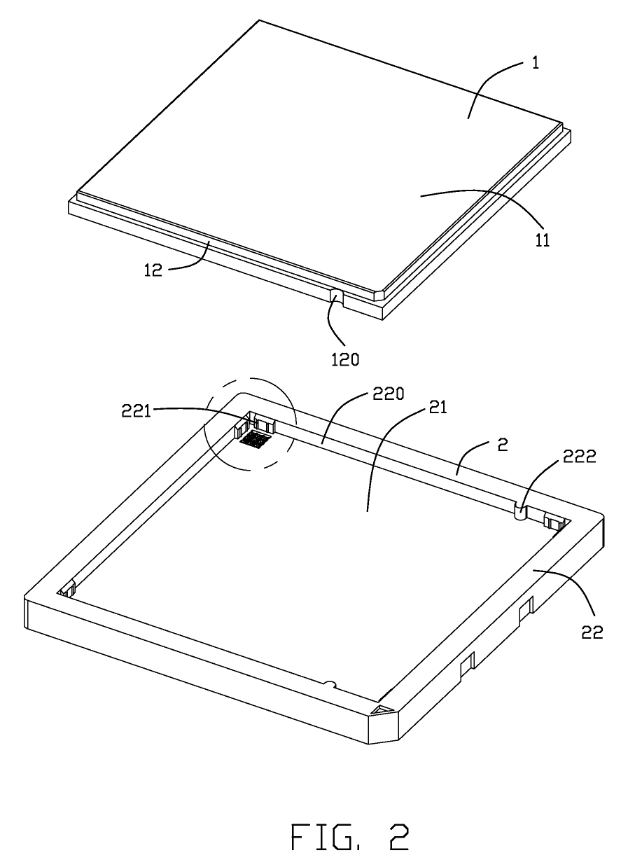

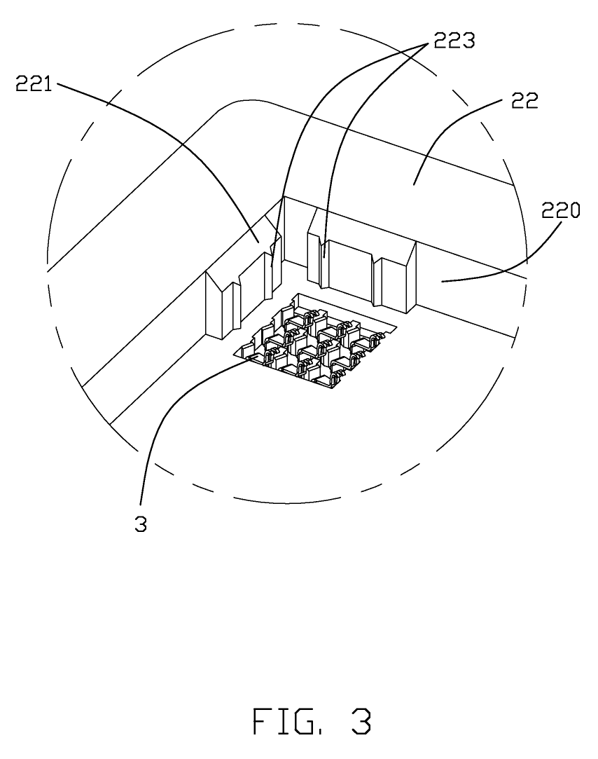

Referring to FIGS. 2 to 4, an electrical connector according to the present invention includes an insulative housing 2 and a plurality of terminals 3 received in the housing 2. A central processing unit (CPU) 1 is received in the electrical connector.

The CPU is configurated rectangular, and includes a main portion 11 and lateral sides 12 surrounding the main portion 11. A pair of notches 120 are defined on two opposite lateral sides 12, respectively.

The insulative housing 2 has a mating face 21 and lateral side wall 22. A plurality of passageways (not labeled) defined on the mating face 21 penetrated the insulative housing 2. And a plurality of terminals 3 are inserted into the passageway, respectively. The FIG. 2 shows only a part of passageways and terminals 3. The mating face 21 accompanied with the lateral side wall 22 to form a cavity (not labeled), the cavity is used to receive the CPU 1. The lateral side walls 22 has inner side surfaces 220 which face the cavity. A pair of protrusion portion 222 are defined on two opposite inner side surface 220 respectively, to match the notches 120 of the CPU. The protrusion portions 222 and the notches 120 work cooperatively to make the CPU 1 assemble to the electrical connector in a correct orientation.

The insulative housing 2 includes four inner side surfaces 220, and every inner side surface defines a pair of fixing block 221, and there is a cutout (not labeled) between the pair of fixing block 221. The fixing blocks 221 defined on opposite inner side surfaces 220 are arranged in face to face. The fixing block 211 has a pair of ribs 223, the ribs 223 extend along a direction perpendicular to the mating face 21. And the rib 223 has a blade (not labeled) which is toward the cavity, a cross-section of the rib 233 is configurated triangular. The ribs 223 and the insulative housing 2 are modeled integrally.

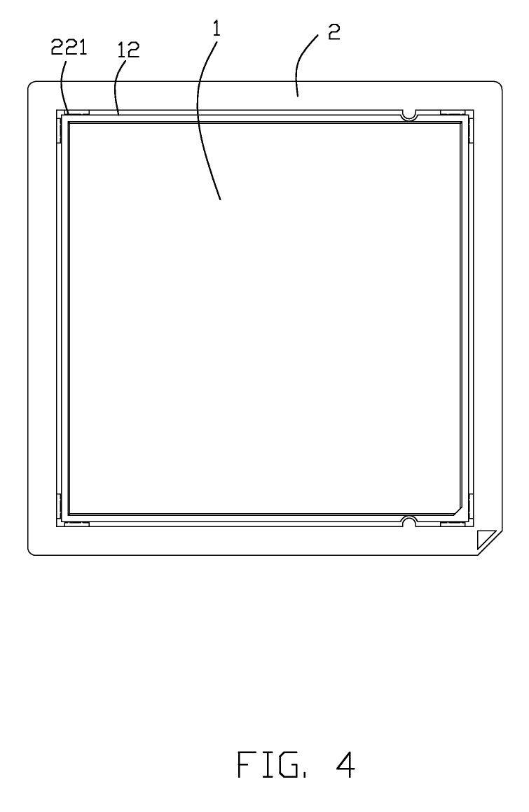

Referring to FIG. 4, the CPU is assembled into the cavity of the insulative housing 2, and the ribs 223 of the fixing block engage with the lateral side 12 of the CPU. So that, the CPU is fixed in the electrical connector stability. And the rib 223 and the lateral side 12 touch in a line because of the blade. So that, the CPU is assembled to the insulative housing 2 easily, and stays in the cavity stability. In other embodiments, the fixing block 221 can be defined on one inner side surface 220, two one inner side surfaces 220 or three one inner side surfaces 220.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for receiving a CPU, comprising:
a plurality of terminals;
an insulative housing comprising a rectangular mating face and receiving the terminals; wherein
the mating face is surrounded by four lateral side walls, and the lateral side walls together with the mating face forms a cavity;
wherein the lateral side wall comprises an inner surface facing the cavity, and the inner surface defines at least two fixing blocks oriented perpendicular to each other, and wherein each fixing block has ribs to engage the CPU.

2. The electrical connector as claimed in claim 1, wherein each fixing block comprises a pair of ribs, the pair of ribs are paralleled to each other, and the rib extends along a direction perpendicular the mating face.

3. The electrical connector as claimed in claim 1, wherein the housing defines at least one cutout between the at least two fixing blocks.

4. An electrical connector comprising:
an insulative housing defining a base and a plurality of side walls extending upwardly from a periphery of the base, said base cooperating with said side walls to commonly defining a receiving cavity;
at least one immoveable fixing block unitarily formed on an interior surface of each of said side walls, said fixing block defining a main face facing toward the receiving cavity in a transverse direction along which said fixing block extends from the corresponding side wall toward the receiving cavity; and
at least one rib unitarily formed on said main face of the fixing block facing toward the receiving cavity for engagement with an electronic package received in the receiving cavity.

5. The electrical connector as claimed in claim 4, wherein said rib is dimensioned smaller than said fixing block in said transverse direction.

6. The electrical connector as claimed in claim 4, where there are two of said rib formed upon said fixing block.

7. The electrical connector as claimed in claim 4, wherein said fixing block is equipped with a beveled top surface for facilitating downward loading of the electronic package into the receiving cavity.

8. The electrical connector as claimed in claim 4, wherein there are plural pairs of said fixing block, each pair being disposed at a corresponding corner of said housing.

9. The electrical connector as claimed in claim 4, further including at least one protrusion portion formed on the interior to be received in a notch of the electronic package.
